(19) United States
(12) Patent Application Publication
(10) Pub. No.: US 2003/0087190 A1
(43) Pub. Date: May 8, 2003

(54) Photosensitive formulation for buffer coatings, film including the formulation, and method for manufacturing electronics using the formulation

(76) Inventor: Recai Sezi, Roettenbach (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/244,280

(22) Filed: Sep. 16, 2002

(30) Foreign Application Priority Data
Sep. 14, 2001 (DE) 101 45 472.4

(51) Int. Cl. G03C 1/725

(52) U.S. Cl. 430/283.1

(57) ABSTRACT

A photosensitive formulation for high-temperature-stable photoresists is based on polyhydroxyamides. The photosensitive formulations are suitable for exposures at 248 nm and below, and following conversion into the polybenzoxazole exhibit a much lower dielectric constant than the corresponding formulations whose base polymers do not contain these protective groups. All of the protective groups are eliminated on heat treatment (baking) while the dielectric constant of the formulations remains as low as that of the base polymers used, which is much lower than the prior art.

### BACKGROUND OF THE INVENTION

1. Field of the Invention

The invention relates to a photosensitive formulation for high-temperature-stable photoresists based on polyhydroxyamides, especially those for deep-UV applications, a film including the photosensitive formulation, and a method for manufacturing electronics using the formulation.

In microelectronics, polybenzoxazoles possessing high-temperature stability are suitable to be used as dielectrics and buffer coatings. The precursors of these polybenzoxazoles, known as poly-o-hydroxyamides, may also be made photoreactive by mixing suitable photoactive components into the formulation of these dielectrics. By heat treatment (baking) at temperatures above 250° C., a poly-o-hydroxyamide can be converted into a polybenzoxazole.

The mechanism that occurs during the cyclization of poly-o-hydroxyamides to polybenzoxazoles is depicted schematically below:

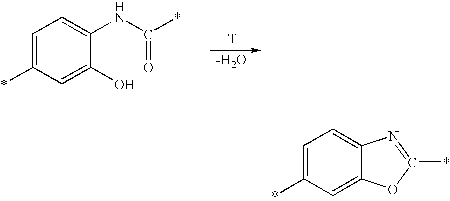

Upon heating, the o-hydroxyamide undergoes cyclization to the oxazole, with elimination of water.

In addition to the thermomechanical stability, the dielectric constant of these materials is an important criterion for their use. The dielectric constant should be as low as possible so that the electrical insulating effect, between conductor tracks or conductor track planes, for example, is good and the electrical performance of the microelectronic component is enhanced.

In order to achieve a high resolution, i.e. of small structures, an exposure apparatus is used that operates at low wavelengths, for example at 248 nm or below. The majority of the buffer coatings used, however, absorb so strongly at this wavelength that sufficient exposure of the added photoactive component down into the lower regions of the coating is virtually impossible. This problem can be solved by raising the transparency of the coating, primarily the transparency of the base polymer of said coating.

Photostructurable polybenzoxazole precursors (such as poly-o-hydroxyamides, for example) have the advantage over the known polyimides that they are positively structurable (reduced susceptibility to defects, since in the majority of cases only a small part of the layer is exposed), can be developed by aqueous alkalis (as opposed to polyimides, which are usually developed with organic solvents), and display a higher chemical and thermal resistance. Moreover, their dielectric constants are generally lower than those of polyimides (following conversion to the polybenzoxazole).

European Patent No. EP 0 264 678 B1, which corresponds to U.S. Pat. Nos. 5,240,819, 5,106,720, and 5,077,378, discloses photosensitive formulations comprising a poly-o-hydroxyamide as their polymer base. The formulations described therein, however, are unsuitable for photostructuring in the range of wavelengths of 248 nm and below since they absorb too strongly within this range. Moreover, these formulations exhibit high dielectric constants.

### SUMMARY OF THE INVENTION

It is accordingly an object of the invention to provide a photosensitive formulation for buffer coatings, a film including the formulation, and a method for manufacturing electronics using the formulation that overcome the hereinafore-mentioned disadvantages of the heretofore-known formulations, films, and methods of this general type and that provide photosensitive dielectrics and/or buffer coatings based on poly-o-hydroxyamides that are readily suitable for exposures at 248 nm or below, that have a low dielectric constant, and that can be photostructured with good sensitivity.

With the foregoing and other objects in view, there is provided, in accordance with the invention, a photosensitive formulation including the following:

a poly-o-hydroxyamide whose hydroxyl groups have been blocked at least in part by tert-butoxycarbonyl groups of the

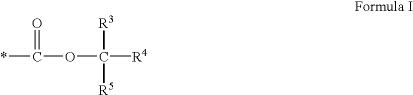

where R³, R⁴, and R⁵ are selected from the following groups: —H, —F, —(CH₂)ₙ—CH₃, —(CF₂)ₙ—CF₃, where n=0 to 10, provided that at least one of the radicals R³, R⁴, and R⁵ is other than hydrogen;

a photoacid; and

a common solvent.

Particular preference is given to using tert-butoxycarbonyl groups wherein the radicals R³, R⁴, and R⁵ are formed by —(CH₂)ₙ—CH₃, especially —CH₃.

Suitable base polymers are poly-o-hydroxyamides some or all of whose hydroxyl groups have been blocked with tert-butoxycarbonyl groups of the Formula I. The fraction of the phenolic OH groups blocked with tert-butoxycarbonyl groups in the Formula I is preferably at least 30%, with particular preference at least 50%. In this case it is also possible for different tert-butoxycarbonyl groups of the formula I to be provided in the polymer. Poly-o-hydroxyamides are polymers obtained by condensing bis-o-aminophenols with dicarboxylic acids, which may where appropriate have been activated. The terminal groups of the polymer can have been blocked by corresponding monovalent groups.

Bis-o-aminophenols are compounds containing two pairs of hydroxyl and amino groups attached to phenyl rings and positioned ortho to one another. The pairs formed from one hydroxyl group and one amino group in each case can be sited on different phenyl rings or on the same phenyl ring.

Particularly suitable photoacids are sulfonium and iodonium salts, and also sulfonated derivatives of succinimide, phthalimide, and naphthalimide, and also diazodisulfone derivatives.

Particular preference is given to poly-o-hydroxyamides corresponding to the general Formula II

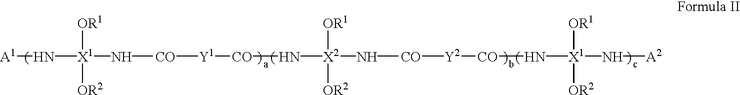

where

R¹ and R² are identical or different and are hydrogen or a tert-butoxycarbonyl group of the general Formula I, at least one of R¹ and R² being formed at least in part by —COOC(R³R⁴R⁵);

A¹ and A² (attached to —NH—) are identical or different and are selected from the group consisting of the following substituents: —H; —CO—(CH₂)ₙ—CH₃; —CO—(CF₂)ₙ—CF₃; —CO—CH═CH—COOH; where n=0 to 10;

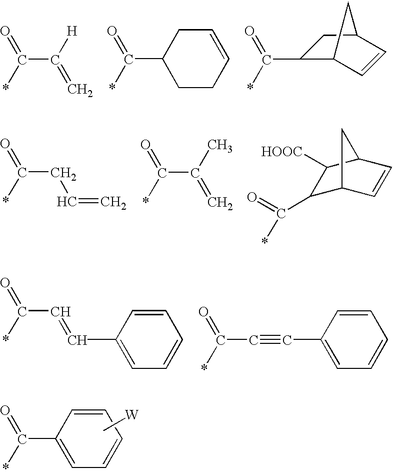

where W=—H, —F, —CN, —C(CH₃)₃, —(CH₂)ₙ—CH₃; —(CF₂)ₙ—CF₃, —O—(CH₂)ₙ—CH₃, —O—(CF₂)ₙ—CF₃; —CH═CH₂, —C≡OH or

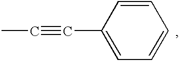

where n=0 to 10;

where, if A² is attached to —CO— and/or C=0, A ² is an OH group;

X¹ and X², independently of one another, are:

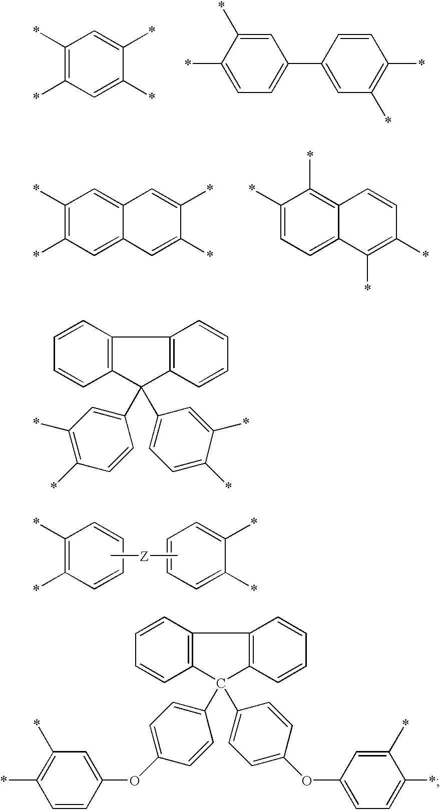

Z is selected from the group of following substituents: —O—;

—CO—; —S—; —S—S—; —SO₂—; —(CH₂)ₘ—; —(CF₂)ₘ— where m=1 to 10;

—C(CR⁶₃)₂— where R⁶ can be identical or different (i.e. independently selected) and can be a hydrocarbon radical having 1 or 2 carbon atoms, and may also have been fully or partly fluorinated, or can be hydrogen, halide or pseudohalide;

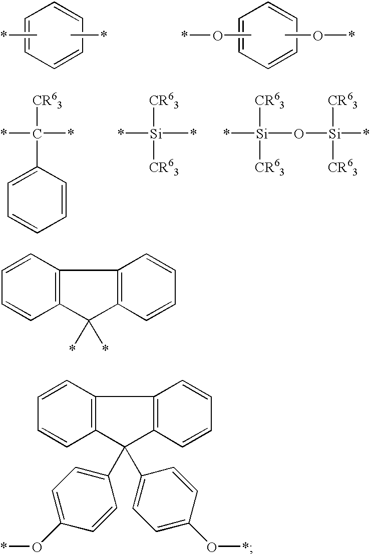

Y¹ and Y², independently of one another, are:

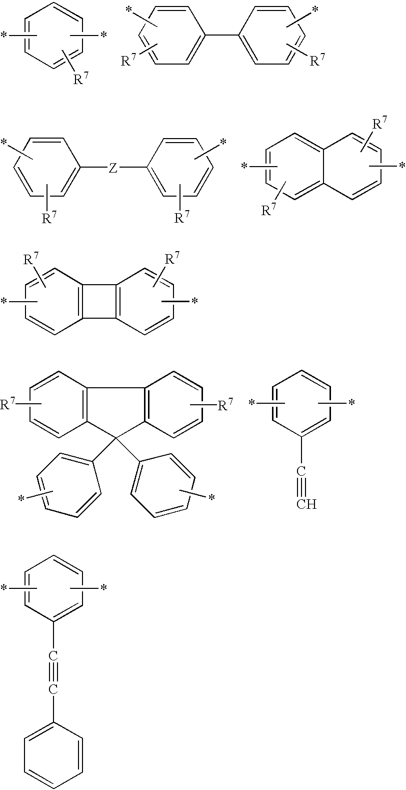

where R⁷ can be:

—H, —CN; —C(CH₃)₃; —C(CF₃)₃; —(CH₂)ₙ—CH₃; —(CF₂)ₙ—CF₃;

—O—(CH₂)ₙ—CH₃, —O—(CF₂)ₙ—CF₃, —C≡CH; —CH═CH₂; —O—CH═CH₂;

—O—CH₂—CH═CH₂; —CO—(CH₂)ₙ—CH₃; —CO—(CF₂)ₙ—CF₃, where n=0 to 10;

and Z is as defined above;

finally, a can adopt any value from 1 to 100; b any value from 0 to 100; and c the value 0 or 1.

In the synthesis of the poly-o-hydroxyamide of the Formula II, no molecules having a uniform molecular weight are obtained. The indices a, b, and c are therefore chosen macroscopically such that they correspond to the maximum of the molecular weight distribution. The molecular weight distribution can be determined by customary techniques, using gel permeation chromatography techniques for example.

In principle, it is possible to use any photoacids. Particularly suitable photoacids are the following compounds:

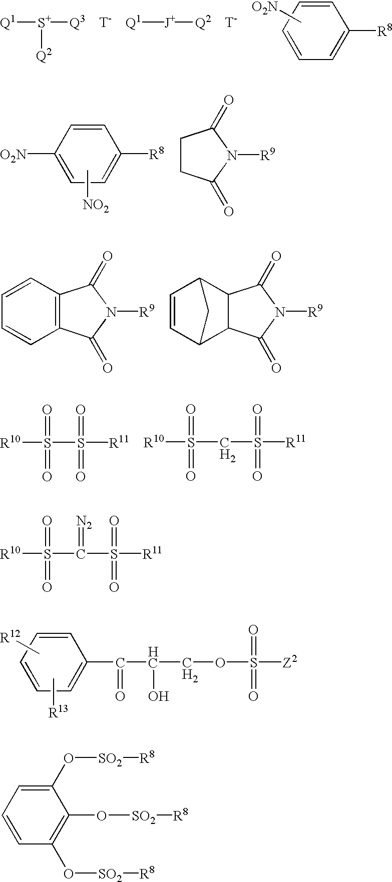

In these formulae, the following is true:

J denotes iodine;

Q¹, Q², and Q³ independently of one another denote —CH₃, —OCH₃, —CF₃ or —OCF₃; and also

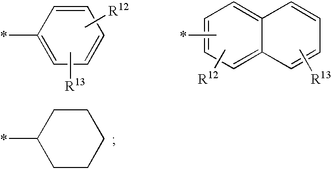

T denotes F₃C—(CF₂)ₙ—SO₃, H₃C—(CH₂)ₙ—SO₃, SbF₆, AsF₆, BF₄, PF₆, (where n=0 to 10); and also

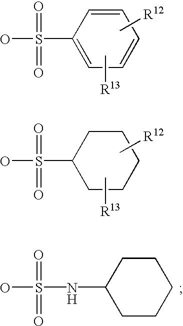

R⁸ denotes

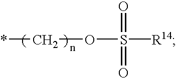

R⁹ denotes the radicals specified in R⁸ or

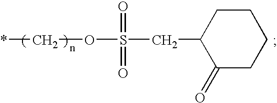

R¹⁰ and R¹¹ independently of one another denote

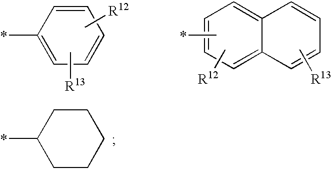

R¹² and R¹³ independently of one another denote —H, —F, —Cl, —CH₃, —OCH₃, —SCH₃, —CF₃, —OCF₃, —OSF₃, —OH, —C(CH₃)₃, —C(CF₃)₃, and also

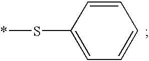

R¹⁴ denotes —(CH₂)ₙ—CH₃, —(CF₂)ₙ—CF₃, and also

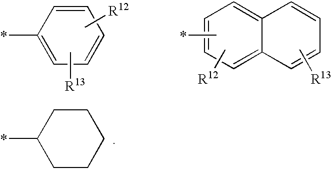

The range of suitable solvents is large and is not intended to restrict the scope of the invention in any way.

Particularly suitable solvents for the formulations that have been identified so far include the following: γ-butyrolactone, N-methylpyrrolidone, dioxane, butanone, cyclohexanone, cyclopentanone, methoxypropyl acetate, ethyl lactate, and/or dimethyl sulfoxide, and also any mixtures of these compounds.

The concentration of the polymer in the solvent is preferably from 5 to 40% by weight, that of the photoacid from 0.05 to 5%.

Examples of suitable sensitizers are the following: pyrene, thioxanthone, fluorene, fluorenone, anthraquinone, benzil, 1,2-benzanthracene, xanthone, phenothiazine, benzophenone, anthracene, Michler's ketone or perylene, which may be in substituted or unsubstituted form and may be present individually or in mixtures.

Examples of suitable adhesion promoters and/or surface-active substances are silanes, especially those containing at least one alkoxy group and, if desired, amino, epoxy, acryloyl, allyl, vinyl, methacryloyl, thiol and/or hydroxyl group. The remaining groups may be alkyl groups. Examples include: allyltrimethylsilane, 3-aminopropyltrimethoxysilane, trimethoxy(3-methacryl-oyloxypropyl)silane, 3-glycidyloxypropyltrimethoxy-silane, trimethoxyvinylsilane, etc.

Examples of suitable photobases are the following:

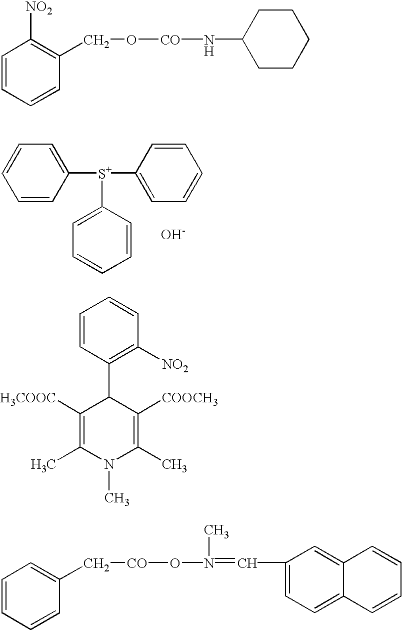

Cyclization to the benzoxazole takes place by heating of the poly-o-hydroxyamide, which is generally in the form of a film, which may where appropriate have been structured. Cyclization may take place directly, i.e., without elimination of the tert-butoxycarbonyl groups of the Formula I beforehand, at relatively high temperatures. Cyclization may also be carried out at lower temperatures in the range from about 80 to 120° C., if the tert-butoxycarbonyl groups of the Formula I have been eliminated beforehand, by acid for example.

Other features that are considered as characteristic for the invention are set forth in the appended claims.

Although the invention is described herein as embodied in a photosensitive formulation for buffer coatings, a film including the formulation, and a method for manufacturing electronics using the formulation, it is nevertheless not intended to be limited to the examples described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the following examples.

### DESCRIPTION OF THE PREFERRED EMBODIMENTS

Referring now to the examples, it is seen that a formulation includes poly-o-hydroxyamides wherein some or all of its hydroxyl groups have been blocked with tert-butoxycarbonyloxy groups. The term “t-BOC protected poly-o-hydroxyamide” does not mean here, therefore, that necessarily all or even only the majority of the hydroxyl groups have been protected.

### EXAMPLE 1

a) Preparation of a t-BOC Protected Poly-o-hydroxyamide with t-BOC Bisaminophenol 1

This polymer is prepared using a t-BOC protected bisaminophenol (t-BOC bisaminophenol 1) of the following formula:

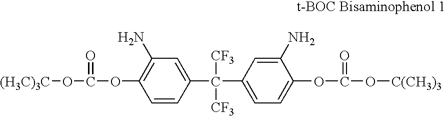

28.3 g (0.05 mol) of t-BOC bisaminophenol 1 are dissolved in 250 ml of distilled N-methylpyrrolidone (NMP). Added dropwise to this solution at 10° C. with stirring is a solution of 8.1 g (0.04 mol) of isophthaloyl dichloride in 80 ml of γ-butyrolactone, and the reaction solution is stirred at room temperature for 16 hours. The end groups in this solution are subsequently blocked by dropwise addition of 3.1 g (0.02 mol) of norbornenecarbonyl chloride in 30 ml of γ-butyrolactone, followed by stirring for 3 hours more. Subsequently, 9.5 g (0.12 mol) of pyridine in solution in 50 ml of γ-butyrolactone are slowly added dropwise to the reaction solution at room temperature and the reaction solution is stirred at room temperature for 2 hours more.

The resulting polymer is precipitated by dropwise addition of the reaction solution to a mixture of isopropanol and water (3:1) and the precipitate is washed three times with fresh precipitant and dried in a vacuum oven at 50° C./10 mbar for 72 hours.

The t-BOC polyhydroxyamide (polyhydroxyamide whose hydroxyl groups have been protected by t-BOC) prepared in this way is readily soluble in solvents such as NMP, γ-butyrolactone, acetone, tetrahydrofuran, cyclopent-anone, diethylene glycol monoethyl ether, and ethyl lactate.

Thermogravimetric analysis (TGA) shows that all of the hydroxyl groups of the poly-o-hydroxyamide have been protected by t-BOC groups.

b) Preparation of a Resist Solution and Photostructuring

The Photoacid I used for this example is as follows:

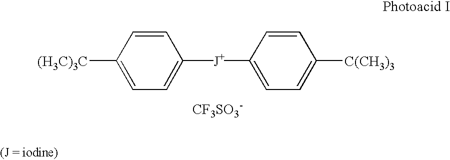

5 g of the t-BOC protected poly-o-hydroxyamide obtained under (a) are dissolved together with 0.1 g of Photoacid I in 10 g of cyclohexanone, the solution is transferred to a plastic syringe, and the syringe is fitted with a primary filter. Using the syringe, the resist solution is applied to a cleaned and dried silicon wafer and the coated wafer is spun in a spin coating apparatus. The resist film is first predried on a hotplate at 90° C. for 120 seconds. The film thickness is 4.1 μm. Subsequently the resist film is subjected to contact exposure in an exposure apparatus, through a mask, using at the same time a 248 nm filter. The silicon wafer is then placed on the hotplate again at 120° C. for 120 seconds. Following development with the NMD-W developer (Tokyo Ohka, diluted 1:1 with water), structures having a resolution of 2 μm are obtained. Heat treatment of the structured film on the substrate in a regulated oven at 350° C. produces resist structures possessing high-temperature stability.

### EXAMPLE 2

a) Preparation of a t-BOC Protected poly-o-hydroxyamide with t-BOC bisaminophenol 2

This polymer is prepared using a t-BOC protected bisaminophenol (t-BOC bisaminophenol 2) of the following formula:

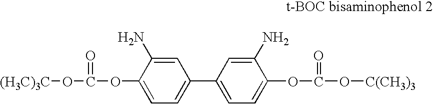

20.8 g (0.05 mol) of t-BOC bisaminophenol 2 are dissolved in 250 ml of distilled N-methylpyrrolidone (NMP). Added dropwise to this solution at 10° C. with stirring is a solution of 11.8 g (0.04 mol) of diphenyl ether 4,4′-dicarbonyl dichloride in 80 ml of γ-butyrolactone, and the reaction solution is stirred at room temperature for 16 hours. The end groups in this solution are subsequently blocked by dropwise addition of 2.1 g (0.02 mol) of methacryloyl chloride in 30 ml of γ-butyrolactone, followed by stirring for 3 hours more.

Subsequently, 9.5 g (0.12 mol) of pyridine in solution in 50 ml of γ-butyrolactone are slowly added dropwise to the reaction solution at room temperature and the reaction solution is stirred at room temperature for 2 hours more. The resulting polymer is precipitated by dropwise addition of the reaction solution to a mixture of isopropanol and water (3:1) and the precipitate is washed three times with fresh precipitant and dried in a vacuum oven at 50° C./10 mbar for 72 hours.

The t-BOC polyhydroxyamide prepared in this way is readily soluble in solvents such as NMP, γ-butyrolactone, acetone, tetrahydrofuran, cyclo-pentanone, diethylene glycol monoethyl ether, and ethyl lactate.

Thermogravimetric analysis (TGA) shows that all of the hydroxyl groups of the poly-o-hydroxyamide have been protected by t-BOC groups.

b) Preparation of a Resist Solution and Photostructuring

The Photoacid II used for this example is as follows:

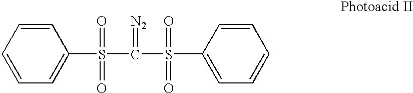

5 g of the t-BOC protected poly-o-hydroxyamide obtained under (a) are dissolved together with 0.1 g of photoacid II in 10 g of cyclopentanone, the solution is transferred to a plastic syringe, and the syringe is fitted with a primary filter. Using the syringe, the resist solution is applied to a cleaned and dried silicon wafer and the coated wafer is spun in a spin coating apparatus. The resist film is first predried on a hotplate at 90° C. for 120 seconds. The film thickness is 3.8 μm. Subsequently the resist film is subjected to contact exposure in an exposure apparatus, through a mask, using at the same time a 248 nm filter. The silicon wafer is then placed on the hotplate again at 120° C. for 120 seconds. Following development with the NMD-W developer (Tokyo Ohka, diluted 1:1 with water), structures having a resolution of 2 μm are obtained. Heat treatment of the structured film on the substrate in a regulated oven at 350° C. produces resist structures possessing high-temperature stability.

### EXAMPLE 3

a) Preparation of a t-BOC Protected Poly-o-hydroxyamide (copolymer) with t-BOC Bisaminophenol 3 and t-BOC Bisaminophenol 4

This polymer is prepared using two different t-BOC protected bisaminophenols (t-BOC bisaminophenol 3 and 4). The end groups are not blocked.

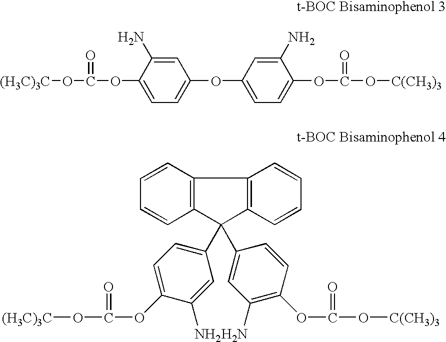

8.7 g (0.02 mol) of t-BOC bisaminophenol 3 and 11.6 g (0.02 mol) of t-BOC bisaminophenol 4 are dissolved in 250 ml of distilled N-methylpyrrolidone (NMP). Added dropwise to this solution at 10° C. with stirring is a solution of 8.6 g (0.02 mol) of 2,2′-bis(4,4′-chlorocarboxyphenyl)hexafluoropropane and 5.6 g (0.02 mol) of 4,4′-chlorocarboxybiphenyl in 100 ml of γ-butyrolactone, and the reaction solution is stirred at room temperature for 16 hours. Subsequently, 7.9 g (0.1 mol) of pyridine in solution in 50 ml of 7-butyrolactone are slowly added dropwise to the reaction solution at room temperature and the reaction solution is stirred at room temperature for 2 hours more. The resulting polymer is precipitated by dropwise addition of the reaction solution to a mixture of isopropanol and water (3:1) and the precipitate is washed three times with fresh precipitant and dried in a vacuum oven at 50° C./10 mbar for 72 hours.

The t-BOC polyhydroxyamide (polyhydroxyamide whose hydroxyl groups have been protected by t-BOC) prepared in this way is readily soluble in solvents such as NMP, γ-butyrolactone, acetone, tetrahydrofuran, cyclo-pentanone, diethylene glycol monoethyl ether, and ethyl lactate.

Thermogravimetric analysis (TGA) shows that all of the hydroxyl groups of the poly-o-hydroxyamide have been protected by t-BOC groups.

b) Preparation of a Resist Solution and Photostructuring

The photoacid III used for this example is as follows:

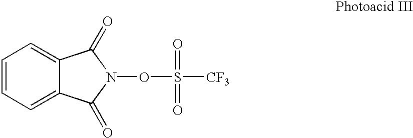

5 g of the t-BOC protected poly-o-hydroxyamide obtained under (a) are dissolved together with 0.1 g of photoacid III in 10 g of γ-butyrolactone, the solution is transferred to a plastic syringe, and the syringe is fitted with a primary filter.

Using the syringe, the resist solution is applied to a cleaned and dried silicon wafer and the coated wafer is spun in a spin coating apparatus. The resist film is first predried on a hotplate at 90° C. for 120 seconds. The film thickness is 3.9 μm. Subsequently the resist film is subjected to contact exposure in an exposure apparatus, through a mask, using at the same time a 248 nm filter. The silicon wafer is then placed on the hotplate again at 120° C. for 120 seconds. Following development with the NMD-W developer (Tokyo Ohka, diluted 1:1 with water), structures having a resolution of 2.2 μm are obtained. Heat treatment of the structured film on the substrate in a regulated oven at 350° C. produces resist structures possessing high-temperature stability.

### EXAMPLE 4

a) Preparation of the Unprotected Polyhydroxyamide (Copolymer):

Bisaminophenol I:

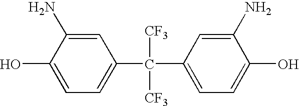

Bisaminophenol II:

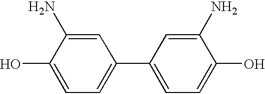

9.2 g (0.025 mol) of Bisaminophenol I are dissolved together with 5.4 g (0.025 mol) of Bisaminophenol II in 250 ml of distilled N-methylpyrrolidone (NMP). Added dropwise to this solution at 10° C. with stirring is a solution of 8.1 g (0.04 mol) of isophthaloyl dichloride in 80 ml of γ-butyrolactone, and the reaction solution is stirred at room temperature for 16 hours. The end groups in this solution are subsequently blocked by dropwise addition of 2.0 g (0.02 mol) of maleic anhydride in 30 ml of γ-butyrolactone, followed by stirring for 3 hours more. Subsequently, 9.5 g (0.12 mol) of pyridine in solution in 50 ml of γ-butyrolactone are slowly added dropwise to the reaction solution at room temperature and the reaction solution is stirred at room temperature for 2 hours more. The resulting polymer is precipitated by dropwise addition of the reaction solution to a mixture of isopropanol and water (3:1) and the precipitate is washed three times with fresh precipitant and dried in a vacuum oven at 50° C./10 mbar for 72 hours.

b) Blocking of the Hydroxyl Groups:

10.0 g of the poly-o-hydroxyamide obtained under (a) are dissolved together with 12.3 g of potassium tert-butoxide in 270 ml of tetrahydrofuran (THF) at room temperature with stirring. After 2 hours, a solution of 19.2 g of di-tert-butyl dicarbonate in 80 ml of THF is slowly added dropwise to the first solution and the resulting reaction solution is stirred at room temperature for 16 hours. The THF solvent is subsequently stripped off on a rotary evaporator, the solid residue is dissolved in 180 ml of ethyl acetate, and the solution is filtered through a folded filter. The solution is subsequently washed with twice 50 ml of 2% strength potassium hydroxide solution, with twice 50 ml of 1% strength aqueous hydrochloric acid, and with twice 50 ml of distilled water. The polymer is precipitated by adding the ethyl acetate solution dropwise to a mixture of isopropanol and water (3:1) and the precipitate is filtered off, washed three times with fresh precipitant, and dried in a vacuum oven at 50° C./10 mbar for 72 hours. Thermogravimetric analysis shows that 84% of the hydroxyl groups have been blocked by t-BOC.

c) Preparation of a Resist Solution and Photostructuring

The photoacid IV used for this example is as follows:

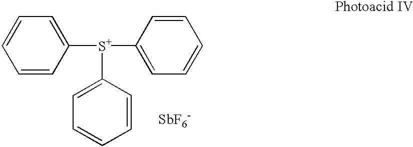

5 g of the t-BOC protected poly-o-hydroxyamide obtained under (b) are dissolved together with 0.15 g of Photoacid IV in 10 g of cyclohexanone, the solution is transferred to a plastic syringe, and the syringe is fitted with a primary filter. Using the syringe, the resist solution is applied to a cleaned and dried silicon wafer and the coated wafer is spun in a spin coating apparatus. The resist film is first predried on a hotplate at 90° C. for 120 seconds. The film thickness is 3.6 μm. Subsequently the resist film is subjected to contact exposure in an exposure apparatus, through a mask, using at the same time a 248 nm filter. The silicon wafer is then placed on the hotplate again at 120° C. for 120 seconds. Following development with the NMD-W developer (Tokyo Ohka, diluted 1:1 with water), structures having a resolution of 1.8 μm are obtained. Heat treatment of the structured film on the substrate in a regulated oven at 350° C. produces resist structures possessing high-temperature stability.

### Example 5

a) Preparation of the Unprotected Polyhydroxyamide:

10.8 g (0.05 mol) of unprotected bisaminophenol II are dissolved in 200 ml of distilled N-methylpyrrolidone (NMP). Added dropwise to this solution at 10° C. with stirring is a solution of 14.8 g (0.05 mol) of diphenyl ether 4,4′-dicarbonyl dichloride in 100 ml of γ-butyrolactone, and the reaction solution is stirred at room temperature for 16 hours. Subsequently, 9.5 g (0.12 mol) of pyridine in solution in 50 ml of γ-butyrolactone are slowly added dropwise to the reaction solution at room temperature and the reaction solution is stirred at room temperature for 2 hours more. The resulting polymer is precipitated by dropwise addition of the reaction solution to a mixture of isopropanol and water (3:1) and the precipitate is washed three times with fresh precipitant and dried in a vacuum oven at 50° C./10 mbar for 72 hours.

b) Blocking of the Hydroxyl Groups:

10.0 g of the poly-o-hydroxyamide obtained under (a) are dissolved together with 10.0 g of tetramethyl-ammonium hydroxide in 270 ml of NMP at room temperature with stirring. After 2 hours a solution of 19.2 g of di-tert-butyl dicarbonate in 80 ml of NMP is slowly added dropwise and the resulting reaction solution is stirred at room temperature for 16 hours. The NMP solvent is subsequently stripped off on a rotary evaporator, the solid residue is dissolved in 150 ml of ethyl acetate, and the solution is filtered through a folded filter. The solution is subsequently washed with twice 50 ml of 2% strength potassium hydroxide solution, with twice 50 ml of 1% strength aqueous hydrochloric acid, and with twice 50 ml of distilled water. The polymer is precipitated by adding the ethyl acetate solution dropwise to a mixture of isopropanol and water (3:1) and the precipitate is filtered off, washed three times with fresh precipitant, and dried in a vacuum oven at 50° C./10 mbar for 72 hours.

Thermogravimetric analysis (TGA) shows that all of the hydroxyl groups of the poly-o-hydroxyamide have been protected by t-BOC groups.

c) Preparation of a Resist Solution and Photostructuring

The Photoacid V used for this example is as follows:

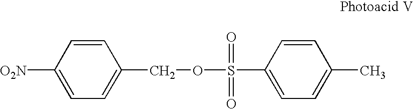

5 g of the t-BOC protected poly-o-hydroxyamide obtained under (b) are dissolved together with 0.15 g of Photoacid V in 10 g of cyclopentanone, the solution is transferred to a plastic syringe, and the syringe is fitted with a primary filter. Using the syringe, the resist solution is applied to a cleaned and dried silicon wafer and the coated wafer is spun in a spin coating apparatus. The resist film is first predried on a hotplate at 90° C. for 120 seconds. The film thickness is 4.1 μm. Subsequently the resist film is subjected to contact exposure in an exposure apparatus, through a mask, using at the same time a 248 nm filter. The silicon wafer is then placed on the hotplate again at 120° C. for 120 seconds. Following development with the NMD-W developer (Tokyo Ohka, diluted 1:1 with water), structures having a resolution of 2 μm are obtained. Heat treatment of the structured film on the substrate in a regulated oven at 350° C. produces resist structures possessing high-temperature stability.

### EXAMPLE 6

a) Preparation of a Resist Solution and Photostructuring

The experiment is conducted exactly as described in Example 1(b) with the difference that in this formulation 0.1 g of perylene sensitizer was added and exposure was performed using a 365 nm filter. Here again, development gives structures having a resolution of 2 μm. Following heat treatment of the structured film on the substrate in a regulated oven at 350° C., resist structures possessing high-temperature stability are obtained.

### EXAMPLE 7 (COMPARATIVE EXAMPLE)

a) Preparation of the Unprotected Polyhydroxyamide:

18.3 g (0.05 mol) of unprotected Bisaminophenol I are dissolved in 250 ml of distilled N-methylpyrrolidone (NMP). Added dropwise to this solution at 10° C. with stirring is a solution of 8.1 g (0.04 mol) of isophthaloyl dichloride in 80 ml of γ-butyrolactone, and the reaction solution is stirred at room temperature for 16 hours. The end groups in this solution are subsequently blocked by dropwise addition of 3.1 g (0.02 mol) of norbornene carbonyl chloride in 30 ml of γ-butyrolactone, followed by stirring for 3 hours more. Subsequently, 9.5 g (0.12 mol) of pyridine in solution in 50 ml of γ-butyrolactone are slowly added dropwise to the reaction solution at room temperature and the reaction solution is stirred at room temperature for 2 hours more. The resulting polymer is precipitated by dropwise addition of the reaction solution to a mixture of isopropanol and water (3:1) and is isolated by filtration and the precipitate is washed three times with fresh precipitant and dried in a vacuum oven at 50° C./10 mbar for 72 hours.

b) Preparation of a Resist Solution and Photostructuring

The experiment is conducted exactly as in Example 1(b) with the difference that here the polymer used was the unprotected poly-o-hydroxyamide obtained under (a). Structuring is not possible at 248 nm.

### EXAMPLE 8 (COMPARATIVE EXAMPLE)

a) Formulation, Film Formation, Heat Treatment, and Determination of the Dielectric Constant:

3 g of the poly-o-hydroxyamide obtained in Example 1(a) are dissolved in 9 g of cyclopentanone and the solution is subjected to pressure filtration. For the following experiment the substrate used is a silicon wafer which has been (sputter) coated with titanium nitride. The formulation is applied to the substrate and spun in a spin coating apparatus for 20 seconds. The film is subsequently dried by placing the substrate on a hotplate at 100° C. for 1 minute. After drying, the film is heat-treated (baked) to convert the poly-o-hydroxyamide into poly-benzoxazole. For this purpose, the coated substrate is introduced into a regulatable oven and the oven is heated to 350° C. (heating rate 3° C./min under nitrogen). After one hour at 350° C. the oven is switched off and after it has cooled the coated substrate is withdrawn again.

The dielectric constant of the resulting polymer film, determined by the capacitive method, is 2.6.

### EXAMPLE 9

The dielectric constant was determined as described in Example 8 but with the addition of 0.1 g of Photoacid I to the poly-o-hydroxyamide. The dielectric constant of the resulting polymer film, determined by the capacitive method, is 2.6. Accordingly, the dielectric constant is unaffected by the addition of the photoacid (which also very largely disappears during baking).

### EXAMPLE 10 (COMPARATIVE EXAMPLE)

The dielectric constant is determined precisely as described in Example 8. The base polymer used is the poly-o-hydroxyamide obtained in Example 7. The formulation consists of 3 g of poly-o-hydroxyamide in 9 g of cyclopentanone. The dielectric constant determined by the capacitive method is 2.85.

### EXAMPLE 11

The dielectric constant was determined in the same way as described in Example 10 but with the addition of 0.6 g of photoactive component to the poly-o-hydroxyamide. The photoactive component used is a mixed tris ester of trihydroxybenzophenone and the naphtho-quinone-4-sulfonic acid of the structure

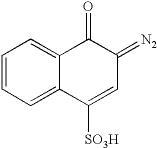

(in analogy to European Patent No. EP 0 264 678 B1, Example 2; this is the minimum amount required to give acceptable structuring on exposure). The dielectric constant of the resist film, determined by the capacitive method, is 2.95.

I claim:

1. A photosensitive formulation comprising:
a poly-o-hydroxyamide having hydroxyl groups blocked at least in part by a tert-butoxycarbonyl group having a Formula I 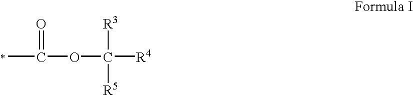
where R³, R⁴, and R⁵ are substituents selected from the group consisting of —H, —F, —(CH₂)ₙ—CH₃, —(CF₂)ₙ—CF₃, where n is an integer from 0 to 10, and at least one of the substituents R³, R⁴, and R⁵ is other than hydrogen;
a photoacid; and
a solvent.

2. The photosensitive formulation according to claim 1, wherein said solvent is a common solvent.

3. The photosensitive formulation according to claim 1, wherein said poly-o-hydroxyamide has a Formula II: 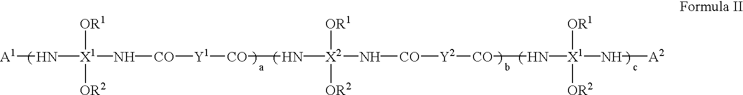
where
R¹ and R² are substituents individually selected from the group consisting of hydrogen and a tert-butoxycarbonyl group having said Formula I, and at least one of R¹ and R² is formed at least in part by —COOC(R³R⁴R⁵);
A¹ and A² are substituents independently selected from the group consisting of —H; —CO—(CH₂)ₙ—CH₃; —CO—(CF₂)ₙ—CF₃; —CO—CH═CH—COOH; where n=0 to 10; 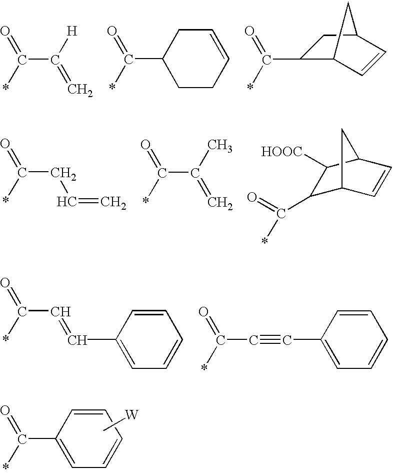
where W is a substituent selected from the group consisting of —H, —F, —CN, —C(CH₃)₃, —(CH₂)ₙ—CH₃; —(CF₂)ₙ—CF₃, —O—(CH₂)ₙ—CH₃, —O—(CF₂)ₙ—CF₃; —CH═CH₂, —C≡CH and 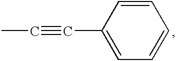
where n=0 to 10;
if A² is attached to at least one of —CO— and C═O, A² is an OH group;
X¹ and X² are substituents independently selected from the group consisting of: 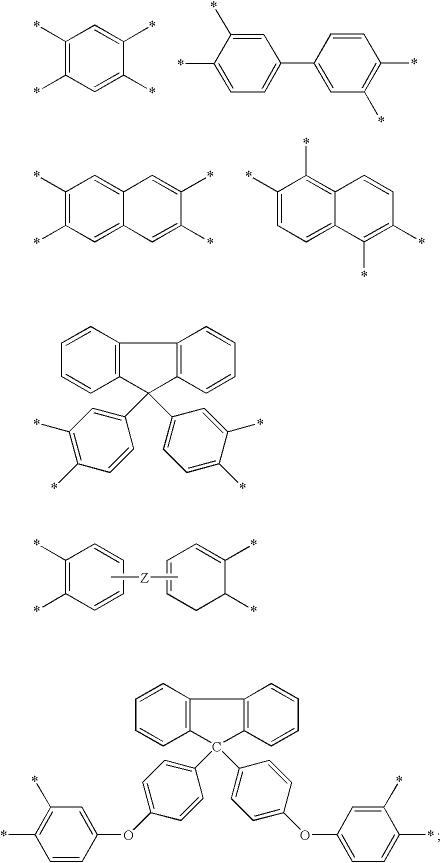
Z is a substituent selected from the group consisting of —O—;
—CO—; —S—; —S—S—; —SO₂—; —(CH₂)ₘ—; —(CF₂)ₘ— where m=1 to 10;
—C(CR⁶₃)₂— where R⁶ is an substituent independently selected from the group consisting of a hydrocarbon radical having from 1 to 2 carbon atoms, a hydrogen, a halide, and a pseudohalide; 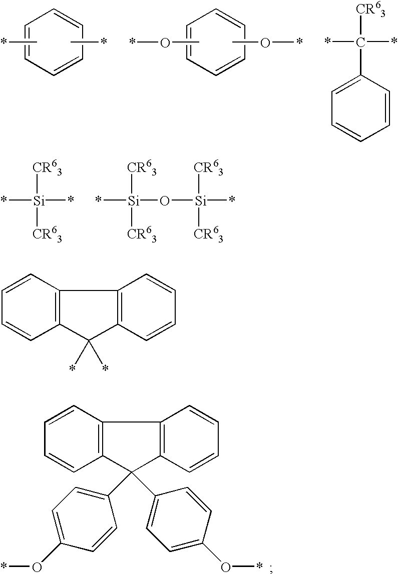
Y¹ and Y² are substituents independently selected from the group consisting of: 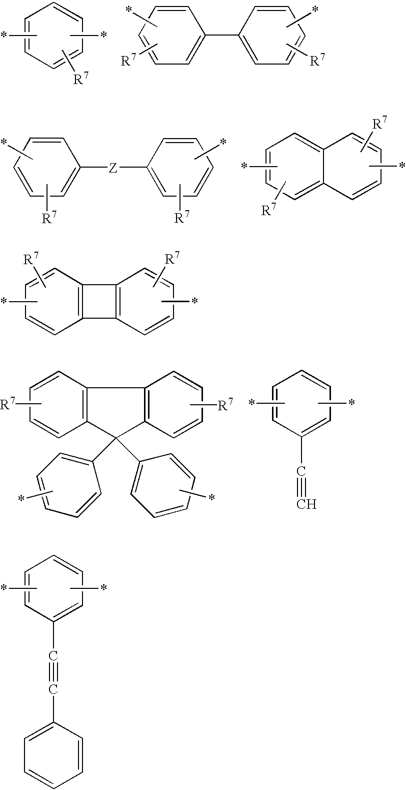
where R⁷ is a substituent selected from the group consisting of —H, —CN; —C(CH₃)₃; —C(CF₃)₃; —(CH₂)ₙ—CH₃; —(CF₂)ₙ—CF₃;
—O—(CH₂)ₙ—CH₃, —O—(CF₂)ₙ—CF₃, —C≡CH; —CH═CH₂; —O—CH═CH₂;
—O—CH₂—CH═CH₂; —CO—(CH₂)ₙ—CH₃; —CO—(CF₂)ₙ—CF₃, where n=0 to 10; and
Z is a substituent selected from the group consisting of —O—;
—CO—; —S—; —S—S—; —SO₂—; —(CH₂)ₘ—; —(CF₂)ₘ— where m=1 to 10;
—C(CR⁶₃)₂— where R⁶ is an substituent independently selected from the group consisting of a hydrocarbon radical having from 1 to 2 carbon atoms, a hydrogen, a halide, and a pseudohalide; and
a is an integer from 1 to 100; b is an integer from 0 to 100; and c is an integer from 0 to 1.

4. The formulation according to claim 3, wherein, if R⁶ is a hydrocarabon radical, R⁶ is fully fluorinated.

5. The formulation according to claim 3, wherein, if R⁶ is a hydrocarabon radical, R⁶ is partly fluorinated.

6. The formulation according to claim 1, further comprising an additive selected from the group consisting of a sensitizer, a photobase, an adhesion promoter, a defoamer, and a surface-active substance.

7. The formulation according to claim 1, wherein a concentration of said poly-o-hydroxyamide in said solvent is from 5 to 40% by weight, a concentration of at least one of said photoacid and said sensitizer is from 0.05 to 5% by weight.

8. A film, comprising a formulation including:
a poly-o-hydroxyamide having hydroxyl groups blocked at least in part by a tert-butoxycarbonyl group having a Formula I 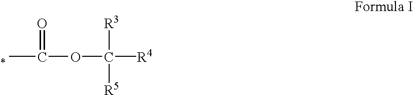
where R³, R⁴, and R⁵ are substituents selected from the group consisting of —H, —F, —(CH₂)ₙ—CH₃, —(CF₂)ₙ—CF₃, where n is an integer from 0 to 10, and at least one of the substituents R³, R⁴, and R⁵ is other than hydrogen;
a photoacid; and
a solvent.

9. The film according to claim 8, wherein said common solvent has been evaporated.

10. The film according to claim 8, wherein said formulation is photosensitive.

11. A method for forming electronics, which comprises:
applying to a wafer a photosensitive formulation including:
a poly-o-hydroxyamide having hydroxyl groups blocked at least in part by a tert-butoxycarbonyl group having a Formula I 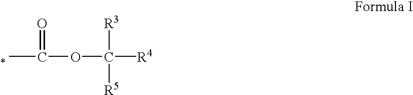
where R³, R⁴, and R⁵ are substituents selected from the group consisting of —H, —F, —(CH₂)ₙ—CH₃, —(CF₂)ₙ—CF₃, where n is an integer from 0 to 10, and at least one of the substituents R³, R⁴, and R⁵ is other than hydrogen;
a photoacid; and
a solvent.

12. The method according to claim 11, which further comprises evaporating the common solvent to produce a film on the wafer.

13. The method according to claim 12, which further comprises selectively exposing the film to light.
